(19) United States
(12) Patent Application Publication
(10) Pub. No.: US 2022/0139161 A1
(43) Pub. Date: May 5, 2022

(54) GAMING DEVICES, SYSTEMS AND METHODS FOR GENERATING PLAYING CARD INFORMATION

(71) Applicant: JPL Investments, LLC, Georgetown, TX (US)

(72) Inventor: Joseph W. Cole, Georgetown, TX (US)

(21) Appl. No.: 17/574,209

(22) Filed: Jan. 12, 2022

Related U.S. Application Data
(63) Continuation of application No. 15/929,979, filed on Jun. 1, 2020.
Application No. 15/929,979 is a continuation-in-part of application No. 16/278,912, filed on Feb. 19, 2019, now abandoned.
(60) Provisional application No. 62/632,662, filed on Feb. 20, 2018.

(51) Int. Cl. G07F 17/32

(52) U.S. Cl. CPC G07F 17/3227; G07F 17/3223

(57) ABSTRACT

A gaming systems and methods of gaming provide multi-player gaming events, such as head-to-head and multi-player pool events, where the players do not play face to face. In a multi-player pool event, players in the pool are presented rounds of games and play individual games for scores. Players with the highest aggregate score for the multi-round event are declared winners. A pool of entry wagers may be distributed to the winners. In other embodiments, players may play games head-to-head. Players may be rated and have to meet rating qualification criteria. In another embodiment, cards are assigned to decks and electronically shuffled to other decks represented by stored card information.

### RELATED APPLICATION DATA

This application is a continuation of U.S. application Ser. No. 15/929,979, filed Jun. 1, 2020, which is a continuation-in-part of U.S. application Ser. No. 16/278,912, filed Feb. 19, 2019, now abandoned, which claims priority to U.S. Provisional Application Ser. No. 62/632,662, filed Feb. 20, 2018, which prior applications are incorporated by reference herein in their entirety.

### FIELD OF THE INVENTION

The present invention relates to methods of presenting and playing games, and gaming machines and gaming systems which are configured to present games.

### BACKGROUND OF THE INVENTION

Many players would like to play casino table games, such as poker or the like, against other players. However, many players are intimidated playing in a face-to-face environment or may believe that they are at a disadvantage compared to other players in their ability to “read” other players. Also, existing server based gaming systems for implementing server-based multi-player games have a number of drawbacks.

A new game, gaming machine and gaming system which addresses these and other issues, is desired.

### SUMMARY OF THE INVENTION

Embodiments of the invention comprise methods of linking players for play of multi-player events, and methods of playing and presenting such events, as well as gaming machines and gaming systems used to present games or events.

One embodiment of the invention comprises a method of linking a player to one or more other players for participation in a multi-player event. The method may include determining available friends for play, determining available events for play, determining available non-friends for play, and displaying that information to the player. In one embodiment, a player may also input a selection of a designated opponent or event. In one embodiment, the method of determining available friends for play may comprise determining if any friends which are identified in an account of the player are in active play of a gaming machine. The method of determining available events may comprise determining events which qualify based upon a rating or skill level of the player. The method of determining other available players may comprise determining players of other gaming machines who have a similar rating or skill level to the player. The player may make a selection of an identified active friend, a designated opponent or event. In other embodiments, the method may also include identify if other members of a group to which the player belongs are available for game play.

In one embodiment, an invitation may be sent to an opposing player to invite them to play, which invitation may be accepted or denied. If the opposing player is not engaged in active play, a message may be transmitted to them to invite them, such as via a communication device.

Another embodiment of the invention comprises multi-player, multi-game events and a gaming system which is configured to present such events. The events may comprise “pool” events where multiple players each place a wager and then play a plurality of games, such as in rounds of play. Preferably, each game that the player plays is assigned a score. The games may comprise, for example, 5 card draw poker and the player's score for each game or round may depend upon the final hand achieved by the player. The score might, for example, be zero or a positive point value when the player achieves a designated winning hand.

The outcome of the event or pool comprises the players with the highest total score. Preferably, two or more players are declared winners and are awarded winnings. The winnings may be paid, for example, by distributing the pool of wagers less any operator rake or commission.

Preferably, the pools have criteria for entering them, such as that a player has a particular rating. The players rating may be updated or evaluated at the end of each event.

In a preferred embodiment, the multi-player pool event is presented to a plurality of players who are each utilizing or playing a gaming machine or device (such as a casino-style gaming machine or a computing device connected to a game server via a network). In this manner, players do not have to play against other players in face-to-face fashion.

Other aspects of the invention comprise a gaming system which includes a server with an associate database of player accounts (which may store player ID, player rating, player friend and group information), and a plurality of gaming machines.

Yet other aspects of the invention comprise a gaming system where game information is generated by one of the gaming machines and is transmitted to the gaming machines of one or more opponent players.

Another embodiment of the invention comprises a gaming machine which is configured to shuffle cards and methods of shuffling. In one embodiment, a gaming machine includes machine-readable code stored in said memory and configured to cause said processor to: (a) store information regarding a first plurality of cards comprising a first deck of cards and a second plurality of cards comprising a second deck of cards; (b) select a first number of cards from the first deck of cards; (c) cause the video display to display images representing the first number of cards as part of the presentation of the card game; (d) determine an outcome of said the game; (e) shuffle the first plurality of cards and said second plurality of cards into a third deck of cards and a fourth deck of cards, comprising iteratively assigning one or more cards from each of the first and second decks of cards to the third deck of cards and one or more cards from each of the first and second decks of cards to the fourth deck of cards until no more cards remain in the first and second decks; and (f) store information regarding the cards comprising the third and fourth decks of cards for use in presenting another card game.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a gaming machine in accordance with the invention;

FIG. 2 illustrates one embodiment of a gaming system in accordance with the invention;

FIG. 3 is a flow chart which illustrates an embodiment of playing and presenting a game in accordance with the present invention;

FIG. 4 illustrates a graphical user interface in accordance with an embodiment of the invention;

FIG. 5 is a flow chart which illustrates an embodiment of playing and presenting a game in accordance with another embodiment of the invention; and

FIG. 6 illustrates aspects of game card generation in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise, but are not limited to, methods and systems for linking players for play of multi-player events, methods of playing and presenting events such as wagering games, and gaming machines and gaming systems.

In a preferred embodiment, the methods of the invention are implemented relative to a gaming machine or gaming system. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

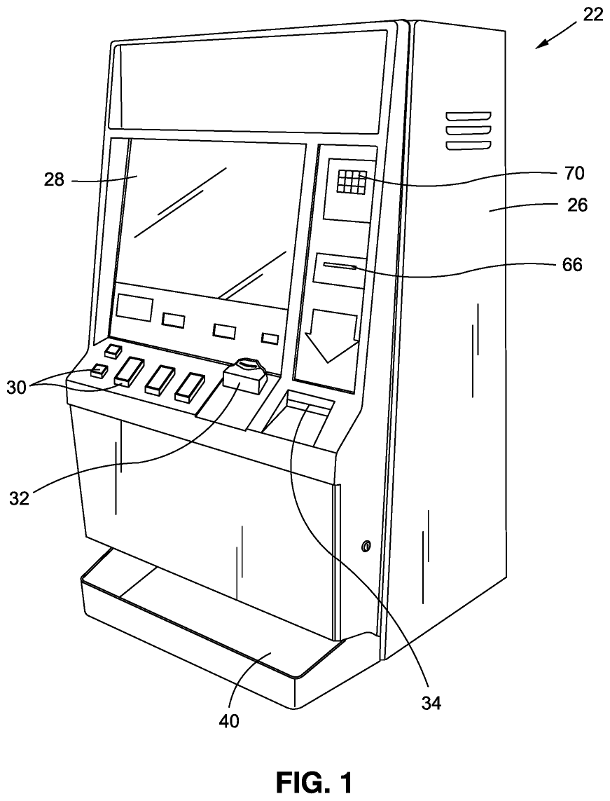

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising displayed playing cards, as detailed below), for determining winning or losing game outcomes and for displaying information regarding awards for winning game outcomes, among other things or, as detailed below, the controller may forward such inputs to another gaming machine which generates the game information which is forward to the controller for use in presenting the game.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 22 is preferably configured to generate game information, such as game cards, in a random fashion (e.g. whereby the game is presented in a manner in which the player(s) cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button (such as one of the buttons 32). Upon such an event and/or the player otherwise signaling the gaming machine to present the game, the controller may be configured to cause the at least one display 28 to display unique information, such as a unique graphical interface or unique game display, including game symbols or other game information (such as graphically represented images of cards, etc.). The controller may accept input from a player of game inputs, such as a request to discard one or more cards or the like, via the one or more player input devices of the gaming machine 22. As indicated above, the machine readable code may be configured in various manners, such as by having various “modules” of software which are designed to implement specific features of the game play or game presentation.

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button (such as implemented via one of the buttons 32) or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible to for the gaming machine to have various other configurations, including different shapes and styles and having different components than as just described. As just one example, instead of being a single player gaming machine, the gaming machine might be a two player or two station gaming machine such as illustrated and described in US Patent Application Publication No. 2004/0137978, which is incorporated herein in its entirety by reference.

As another example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

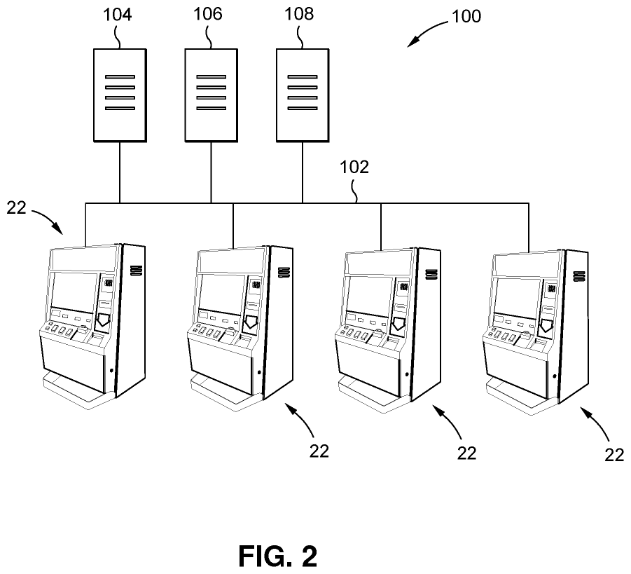

In accordance with the invention, and as illustrated in FIG. 2, a gaming system 100 includes at least two gaming machines 22, and preferably a plurality of gaming machines 22. In one embodiment, the gaming machines 22 may communicate with one another, such as over a network 102. The system 100 preferably also includes other features or elements. For example, each gaming machine 22 may communicate with a player tracking server or system 104, an accounting and/or ticketing system or server 106, a game server 108 a bonusing system (not shown), a tournament system (not shown), other gaming machines (not shown), gaming tables (not shown), and external devices such as cashier stations, video displays, etc. Of course, various functionality (such as bonusing and player tracking, etc. might be implemented by a single server or multiple servers).

In one embodiment, the servers may comprise computing devices which have a processor which is configured to execute machine-readable code which is stored in an associate memory, and includes a communication device or interface to permit communications with other devices.

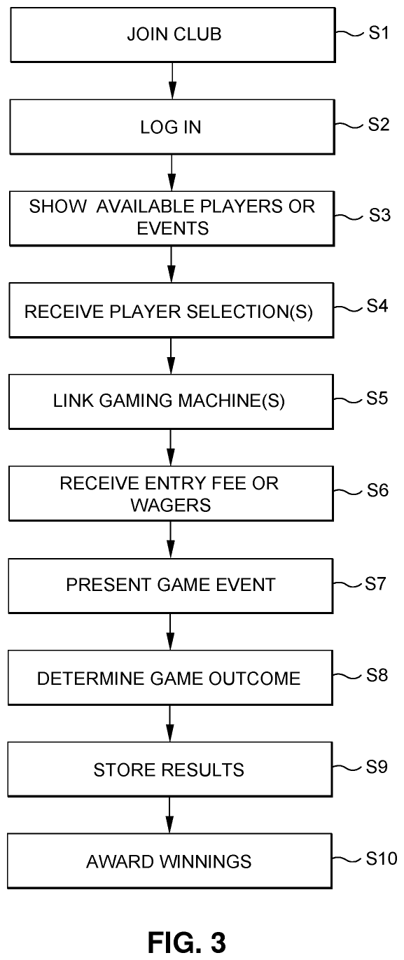

One embodiment of a method in accordance with an embodiment of the invention will be described with reference to FIG. 3. This method includes methods of linking players for participation in multi-player events, methods of presenting and playing multi-player events such as wagering games, and methods for generating game information.

In a first step S1, a player may be required to join a casino club and/or a game club. For example, the player may be required to join a casino player tracking club. This may comprise the player providing identifying information and then being issued a player tracking card having an identifier which associates the player's tracking account with the player and their card. In addition, or alternatively, the player may be required to join a game club. In one embodiment, for example, the player may be required to pay a fee or dues, such as a per month or per game fee in order to play games of the invention. This step might be performed at a gaming machine, a kiosk type device, at a cashier station, online or the like.

In one embodiment, players may assign themselves nicknames. For example, when players signed up for the player's club or the game club, they may pick a nickname. This nickname may be the only name that is displayed to other players, hiding their true identity. In addition, or alternatively, the player may be assigned an ID, such as an ID number.

In embodiment, information other than player identification information may be associated with the player's account, such as player preferences. In one embodiment, player preferences might include the identity (such as by player number or user name) of friends, or the association of the player with one or more groups. In one embodiment, in order to be linked as a friend, the player might have to invite another player to be a player friend and that person might need to accept. Similarly, the player might need to request to join a group of other players, such as by sending a request which must be accepted or by being invited.

In one embodiment, a system of the invention may include a database of player accounts, where each player account is tied to the player's ID, and wherein the player accounts may include various associated information, such as one or more player friends (such as identified by player ID), groups (which might be identified by a name, group ID or the like), and a player rating.

In a step S2, the player preferably identifies themselves at a gaming machine, such as by inserting their player tracking card to the card reader of the gaming machine. The player may be required to enter a PIN number or the like in conjunction with the use of their card. Of course, in some embodiments, use of a physical card may be eliminated, such as by the player simply logging into their account by inputting account information or the like (such as by typing in a user name and password). In one embodiment, the gaming machine either uses information directly from the card or information stored in an account tied to the card (such as at the player tracking system/server 204) about the player.

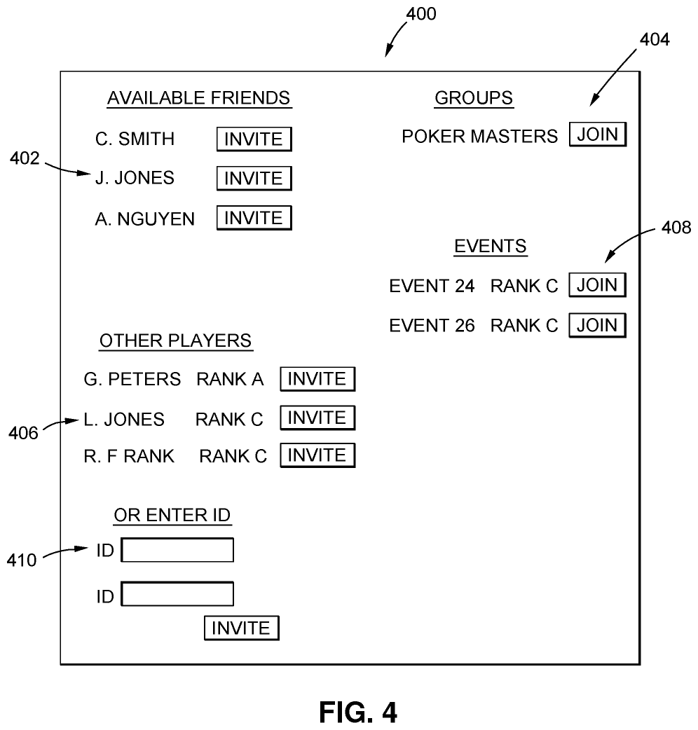

In one embodiment, in a step S3, information is displayed to the player regarding available games or players, such as different tournaments that the player can select from (as described in more detail below), groups of players, or individual players. One example of a graphical user interface 400 which may be displayed to the player via a display of the gaming machine is illustrated in FIG. 4.

In one embodiment, when a player logs into the system, the gaming machine that the player is playing transmits player identification information to the system and then the system (such as the player tracking server 104) may analyze the player's preferences and identify any “friends” of the player who are currently logged into the system (e.g. such as by having identified themselves at one of the gaming machines) and then display a list of those friends 402. The system may also show any groups of players 404 that the player is associated with, such as groups having one or more players who are in active play (e.g. such as by having identified themselves at one of the gaming machines). The system may also display a list of other players 406 (e.g. not friends or in the player's group(s)) who are currently active on another gaming machines and who are not already engaged in active game play.

In yet another embodiment, the system might display to the player a number of available games, events or pools 408 which the player may enter (rather than, or in addition to, the names of players or groups).

In one embodiment, a player is assigned a skill level or rating. For example, players might be rated from 1-10 in skill level, or level A, B or C, etc., based upon a plurality of factors. Such factors might comprise the number of games the player has played, the outcomes of games played by the player, and/or a skills test or questionnaire which is provided to the player. The player's skill level might start at a base level (such as 1) and then move up or down based upon evaluation of these factors. For example, winning game outcomes may increase the player's skill level, while losing outcomes might decrease it. The player's skill level might be stored in association with their account. In one embodiment, a player might only be permitted to play games in the same or a higher skill level than their level (for example, in one embodiment, a player with a rating of 5 might be permitted to play other players with a rating of 5 or higher, but not lower), or might only be permitted to play against other players having the same or a higher skill level. Thus, in one embodiment, when the player logs in, their skill level may be determined (such as from their associated account) and then when the list of players and/or game is being created, the system may filter the other players or the available events based upon this skill level criteria. In other embodiments, a player might be permitted to play a player of a lower skill level, but only if the player with the higher skill level invites the player of the lower skill level and the player of the lower skill level accepts the challenge to play. In some embodiments, if a player forms a “friend” relationship with another player, then the player can play any friend, regardless of the relative rankings of the two players.

In a step S4, one or more player selection inputs are received. This may comprise the player selecting one or more opponent players from the list of displayed players or selecting a particular event or pool to join. Of course, the player might also be selected by another player. Essentially, a player may select another player or players against whom they would like to play or the player may, once logged into the gaming machine and noted as an available opponent on the list of players of another gaming machine, be selected by the player of another gaming machine as an opponent. In one embodiment, the player who selects another player or players may be referred to as an “initiating” player and their gaming machine may be referred to as an initiating gaming machine, while the other players may be referred to as opponents who play opponent gaming machines. As noted above, such a player might comprise a friend or might be another player. Upon making a selection of one or more players, the system may send out an invite to the one or more other players. The invite may be displayed on the other player's gaming device, such as by displaying “Player X123 has invited you to play a game of Super Poker against them. Do you Accept or Decline?”, whereupon the player may make an accept or decline input. Of course, if the player(s) decline, then the inviting or initiating player may be notified and they may then make other invitations. In one embodiment, the player's rating or ranking may be displayed in such an invitation, whereby the other player knows the ranking of the inviting player and can determine whether to accept the challenge based at least in part upon the ranking of the inviting player.

In another embodiment, the player might select a group or a particular event or pool, such as described in more detail below. In such an event, the player may join players of their group in game play or join an event or pool that is beginning.

In other embodiments, a player might invite friends to play when those friends are not currently playing on the system. For example, a player might log into the system and the system might show them their list of friends (who may or may not presently be playing on the system). If the player selects a friend who is not presently playing, the system (such as one of the servers) may send a message to the friend (such as via text, SMS, email or the like to a communication device of the friend, such as their computer/phone) inviting the friend to accept the invitation and, if accepted, log onto a gaming machine (at a casino or remotely) in order to play.

In yet another embodiment, a player might be provided with one or more codes, IDs, nicknames or the like which the player may input in order to link to specific players, groups or games. For example, instead of providing a list of players/groups and/or events, or in addition thereto, the player might be permitted to input one or codes or IDs 410, such as illustrated in FIG. 4. The IDs might, for example, be IDs corresponding to certain other players, such as friends (for example, one player might provide their ID to another player) or a certain event might have a particular event ID. The player may directly enter the one or more IDs in order to link to other players or groups. Once again, the ability to directly enter an opponent or event may be overridden if the opponent or game/event does not meet the player's rating/skill criteria.

In one embodiment, a list of all events, friends/opponents, etc. might be listed and then a player might only be permitted to select those which meet the skill/rating requirements described herein. In other embodiments, only those events, players, etc. that are determined to meet the skill/rating requirements as described herein may even be displayed via the graphical interface to the player (e.g. by being filtered before they are displayed).

In some embodiments, the graphical user interface may be customizable by the player. For example, the player might be presented with options such as “display friends”, “display events”, “display groups”, etc. where the player may select one or more or all of those selections, whereby the information which is displayed by the graphical user interface is customized.

In a step S5, the player is linked to the one or more opponents (including other players of a selected event). In one embodiment, this may comprise linking the gaming machines of the player and the opponent(s), such as by placing them in communication with one another. For example, a first player A might select player B as an opponent, whereby the gaming machines which player A and player B are playing are linked (in the configuration where the gaming machine is a two-station or two-player gaming machine, those stations may be linked if they are not already linked; as in one embodiment, when using such a two-player or two-station gaming machine, players may be limited to simply playing one another at that gaming machine). In other embodiments, this may comprise linking the player's gaming machine to a particular event, such as a multi-player tournament as described below.

In a step S6, the player preferably places wager or plays any required entry fees. This may comprise, for example, the player providing currency to the bill validator of the gaming machine or providing a value ticket to the ticket reader. Of course, other means for providing funds might be utilized, such as electronic funds transfer, bank card or the like. In one embodiment, a player may associate funds with their account (such as their player account or a separate gaming funds account associated with the player), such as by transferring funds to the account from a bank account, by deposit with a cashier or at a gaming machine, etc. Once the player has available funds, the player may pay any required entry fee (such as to join a particular tournament or pool game) or to place wagers (such as one or more wagers to play a head-to-head poker game against another player), and the player's funds balance (such as in their player funds account or gaming machine credit balance, is reduced by the amount of such fees/wagers).

In a step S7, game information is generated and is presented to the players of the game. In one embodiment, the game may comprise a poker game. In such a configuration, cards are dealt to each player and/or to the “community.” Depending upon the rules, various number of cards may be dealt, in various sequences, and with or without the ability to discard cards and obtain replacement cards. Also, the game may require certain bets, such as an ante bet or call bet, and may allow various other bets at various times of the game. Such bets may be placed by the players by placing input to their gaming machines to wager funds that they have associated with their machines. It will be appreciated that the particular game information and the steps involved in presenting and playing the game may vary, such as depending upon the particular game which is presented.

As one example of the invention, player A might invite player B to play a head-to-head game of poker. In one embodiment, each player may be required to place an ante wager. The players might then each be dealt a five (5) card initial hand of cards. Each player might then be required to place an additional wager, such as a play wager, in order to remain in the game (and if the player does not, the player folds). Assuming the players both place a play wager, the players may then discard and draw one or more cards to form a final five (5) card hand. Each player might then be required to place a call wager or fold. If the players both place a call wager, then the outcome of the game is determined by comparing the ranks of each player's final hand according to poker hand rankings. Of course, this is just one example of a game played in a player vs. player format.

In a step S8, the game outcome is determined, such as based upon the dealt cards and player inputs, as applied to the rules of the particular game. In one embodiment, the outcome of the game may be determined by the game server 108, while in other embodiments, the game outcome might be determined by the initiating game player's gaming machine (and then transmitted to the opposing player's gaming machine).

The game results may be stored at the gaming machine and/or at a linked remote casino server or system for tracking, as in a step S9. The game outcome may be used to update each player's skill level or rating. For example, the game outcome may be transmitted to the player tracking server which calculates a new player skill level/score and saves the score to the player's account. In one embodiment, the player's skill level may increase faster for wins against higher ranked players as compared to players of the same rank.

In a step S10, winnings are awarded to the one or more winning players, such as based upon the game rules. The winnings are preferably credited to the winning player's gaming machine, such as to their credit balance. In one embodiment, this may comprise one gaming machine transferring funds to another gaming machine. For example, during the course of a game, player A may wager $200 and player B may wager $200. If player B wins the game, $200 may be transferred from player A's gaming machine to player B's gaming machine. In another embodiment, the funds may be transferred out of or to the player's accounts (such as by crediting player B's account with $200).

A player might access funds from their account and/or may cash out of their gaming machine when they are done playing. This may comprise, for example, providing a cash-out input and then having the gaming machine issue a value ticket to the player in the amount of their credit balance. In one embodiment, such a ticket may be issued and redeemed as discussed above. In another embodiment, the ticket may be issued and redeemed as detailed in U.S. Pat. No. 8,469,799, the contents of which are incorporated in their entirely herein by reference.

It will be appreciated that the functionality described above may be implemented by software executed by the processors of the gaming machines and/or server(s). In some embodiments, functionality may be implemented by a combination of the gaming machine(s) and/or server(s) (for example, a gaming machine might display a graphical user interface based upon image information stored in a memory thereof, but including data or information which was generated by one of the servers and transmitted to the gaming machine).

It will be appreciated that the method might include additional steps or features, might comprise fewer steps, and the steps might be performed or implemented in other orders.

The principles of the invention may be applied to the presentation of card games other than poker games (including, but not limited to games such as blackjack, baccarat, Pal Gow and others) and to games which do not comprise card games (including dice games), and wherein such games might not comprise traditional wagering games, but might comprise other games such as Yahtzee, Scrabble or the like. The invention has particular applicability, however to games which are played head to head among two or more players (e.g. where the players are not playing against a machine, a paytable or a dealer).

When the game system is operated by a casino or “house”, the casino may charge fees in order to obtain compensation for the service. As noted, in one embodiment, the casino might charge each player a sign-up fee or a monthly fee or the like. In other embodiments, the casino might apply a rake or vigorish to all bets or entry fees. The casino might also or alternatively charge cash in or cash out fees to the players.

In one embodiment, game criteria might be applied to certain skill level games. For example, each skill level might have a minimum wager or maximum wager limit, such as a low minimum and maximum wager for low skill level player games and a higher minimum and maximum wager for higher skill level games.

In one embodiment, a player might be able to refuse a challenge to play from another player. In another embodiment, a player may not refuse to play another player, at least if the player is of a compatible rank/skill level.

The principles of the invention may apply to games with more than two players. For example, an initiating player might select 3 opponents to play a 4 player poker game.

As noted below, in one embodiment, the initiating player's gaming machine may generate the game data used in the game (such as information regarding dealt cards). In another embodiment, the initiating player's gaming machine may generate the game data for a first game, and each opponents gaming machine may generate the game data for later games involving the same players (whereby each player's gaming machine generates, in turn or sequence, the game data for games between the players). In other embodiments, the game data may be generated by the game server 108.

Of course, other game features may apply, such as game time limits and the like.

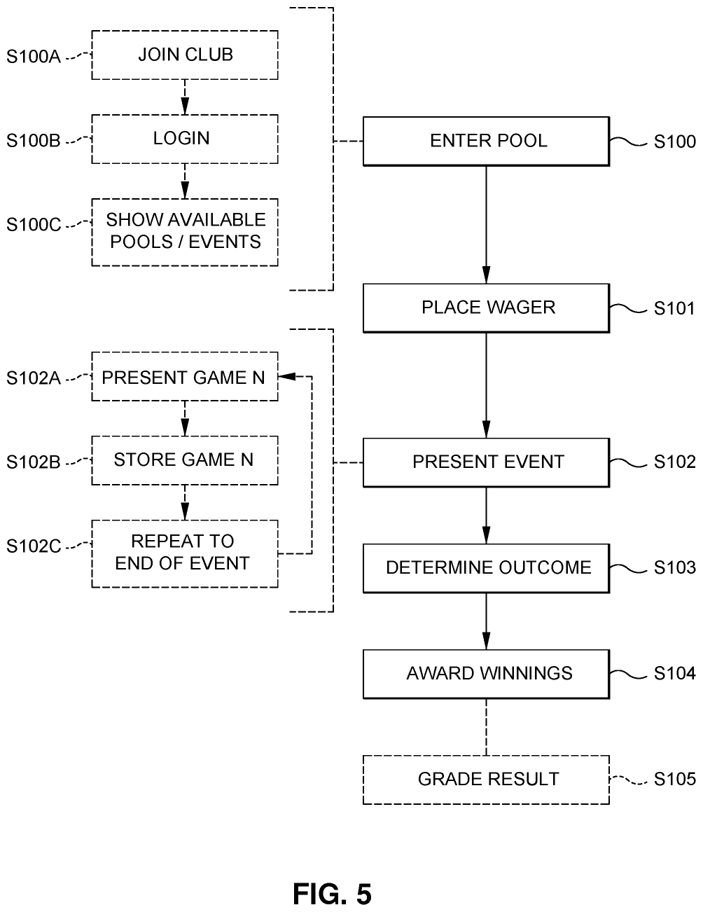

In the example of the embodiment described above, one or more players may play individual games against one another for outcomes. In another embodiment of the invention, as will be described with reference to FIG. 5, players may play tournament-style games against one another, wherein the outcome of the tournament is determined based upon the play and outcomes of two or more games.

In a step S100, a player may enter or join a multi-player event. This may comprise the player entering a player “pool” event of two or more players. As with the previous embodiment, the ability of a player to enter an event or pool may require that the player be a member of a club and/or might require that the player have a particular rating or ranking. Thus, as illustrated in FIG. 5, a player might be required to join a player's club or casino club S100A and then the player might be required to login to the system in order to identify themselves, as in step S100B. In the case where a casino is operating the game and has an existing player tracking system, that player identity might be utilized. In other embodiments, a separate players' club might be created just for tracking eligibility and game play of players in the player pools.

As indicated above, in one embodiment, the player may have a ranking or rating tied to their club identity and the player may only be allowed to enter events or pools having a rating criteria which matches the player's rating. As one example, players might be ranked as A, B and C level players, where A is the highest ranking. Players might only be permitted to enter events having their designated ranking, or might be permitted to enter events having their ranking or a ranking which is higher, but not lower (e.g. a player with an A ranking could not enter a B or C ranked event in order to avoid having that player take advantage of lower ranked players, but a player with a C ranking could enter any event, including by electing to enter an event with higher ranked players, such as to challenge themselves).

In one embodiment, as in step S100C, a list of available events or pools might be presented or displayed to the player, such as at a gaming machine. In one embodiment, all events or pools might be displayed. In another embodiment, only those events or pools that the player qualifies to enter (such as via their ranking or rating) might be displayed to the player. The action of entering a pool in step S100 may then comprise the player selecting one of the pools or events from the displayed list. The pools or events might be created by a casino and might comprise pools having various rankings, various buy-ins, various start times, various numbers of players and involve the player of different games. As one example, such a table might look as follows:

TABLE 1

| | | Number of | | Player | |
|---|---|---|---|---|---|
| Pool # | Start Time | players | Buy-In | Rank | Game |
| #3491 | 8:00PM | 10 | $100 | B | 5 card |
| | | | | | draw poker |
| #4822 | 9:00PM | 20 | $500 | A | 5 card |
| | | | | | draw poker |
| #6855 | 9:00PM | 35 | $20 | C | 5 card |
| | | | | | draw poker |
| #1322 | 9:30PM | 20 | $100 | B | 7 card |
| | | | | | stud poker |

In a step S101, the player places a wager. In one embodiment, the amount of the wager may be a fixed amount, such as tied to the event or pool that the player has selected. In other embodiments, the amount of the wager might vary. For example, relative to the pools displayed in Table 1, a player might have a B ranking. The player might thus select from pool #3491 or #1322. In one embodiment, the player might pay the wager or buy-in from a credit balance associated with the gaming machine, via a gaming account, wallet, card or the like and then use funds from that account.

As indicated, the events may have qualifying criteria which limit the players who may enter. In one embodiment, the events or pools which are displayed to the player may be pre-filtered to only comprise the sub-set of events or pools for which the player qualifies. Alternatively, the system (such as the game server) may receive a request from a player to enter a particular event and may then compare the player's rating or other status to the criteria for the event to determine if the player is eligible to enter the event. If not, the player's request may be decline (such as with information about the player's failure to qualify and information about their rating and selection of matching events).

In a step S102, the event is presented. In one embodiment, the event is a multi-game, multi-player event. Thus, in one embodiment, the event is not presented unless at least two players join the event. In one embodiment, the event might start at a designated time or might simply start when a minimum number of players is achieved or when all player positions are full. For example, an event might offer a maximum of 10 players and might start as soon as 10 players have joined or at a designated time if 10 players do not join before the designated time.

An embodiment of such an event will be described with reference to steps S102A-102C

In one embodiment, the event involves the presentation of a plurality of games. The games may be of various types and have various features. In one embodiment, the games are poker-type games. As one example, each game might comprise a five (5) card draw poker game where each player is dealt an initial 5 card poker hand, is permitted to discard one or more (and depending upon the rules, up to all) of the cards and is then dealt a replacement card for each discarded card. Of course, the game might comprise other types of games, such as seven (7) card poker, blackjack or any number of other games, wherein such games may utilize cards, dice or other game apparatus and may have any number of steps or rules.

In a preferred embodiment, the game is presented to a player via a gaming machine or device (as indicated above, the gaming machine or device may comprise a casino-style gaming machine such as illustrated in FIG. 1, or might comprise a presentation terminal, or might comprise a computing device such as a desktop or laptop computer or mobile device of the player), such as in step S102A. Thus, in a preferred embodiment, game data is generated by the game server 108 and is transmitted to the player's gaming device for display via the display thereof. For example, the game server 108 may generate information regarding selected cards and transmit that information to the player's gaming device, whereupon the gaming device displays graphical representations of the cards to the player.

In one embodiment, each game is played as a “round” where each of the players plays a game. The game might have 10 rounds, wherein each player plays 10 games (in this case, 10 hands). In this configuration, all players play the same number of games (and thus each player's total score is based upon a number of games or hands which is the same as all of the other players in the pool).

In one embodiment, the outcome of each game is determined and, most preferably, a score is assigned to the outcome, such as in step S102B. In one embodiment, each player is assigned a score for each played game. In an embodiment where the game comprises poker, the score of the player's hand might depend upon the ranking of the player's hand to all other players, might depend upon the ranking of the player's hand to a table of ranked hands or the like. As one example, 10 players might play the event. Winning poker hands may be ranked, such as in accordance with traditional rules. At the end of the game, the player with the highest ranked hand might be assigned 10 points, the player with the next highest hand might receive 9 points, and so on. As another example, winning poker hands might be assigned point values for a pay table, such as illustrated in Table 2:

TABLE 2

| Final Hand | Points |
|---|---|
| Royal Flush | 250 |
| Straight Flush | 50 |
| 4 of a Kind | 25 |
| Full House | 9 |
| Flush | 6 |
| Straight | 4 |
| 3 of a Kind | 3 |
| 2 Pair | 2 |
| Pair of Jacks or Better | 1 |
| All other outcomes | 0 |

In this configuration, the player's final hand for each game is compared to the ranking table and is assigned the corresponding score. In this configuration, unlike standard multi-player poker played at a gaming table or online, one single player is not declared to be the winner of the poker game. Instead, points or scores are assigned to all players, although only a single player might receive points (as just one example, where player hands are compared to a table of winning hands and only a single player received a hand on the paytable, only that player would receive points).

In one embodiment, a plurality of games (two or more) are presented in repeat fashion, as indicated at step S102C. In one embodiment, the event may comprise a predetermined number of games or games might be played until a predetermined period of time expired or the like.

As one example, at each round of play, each player plays a game of 5 card video poker. Each player is dealt an initial 5 card hand (preferably each player is dealt their own hand), each player makes an election of cards to hold/discard, replacement cards are dealt to each player for any cards discarded by the player, and then the outcome of that game is determined by the player's final 5 card hand. A score is assigned to each player's hand at the end of each round.

In some embodiments, timers or play rules may be implemented to ensure that some players do not impede the progress of each game. For example, if a player does not designated cards to hold or replace in a designated period of time after their initial hand is dealt, the result of the game as to that player may be determined from their initially dealt hand, or the player might be deemed to have forfeited the hand (e.g. the player automatically receives 0 points).

In a step S103, the outcome of the event is determined. In a preferred embodiment, an aggregate score is determined for each player by summing the individual game scores for the player. The players with the highest scores are declared to be the winner. In particular, preferably at least two players, and optionally more, are declared to be the winners. As one example, the two, three or more players with the highest scores may all be declared as winners of the event.

In a step S104, winnings are preferably awarded to the winning player(s). In a preferred embodiment, the event is configured as a pari-mutuel event where the winners split a pot, such as based upon their rank. As one example, the players with the top three scores in the event may be declared to be winners. The first place player (the player with the highest score) may be awarded a first award, such as 60% of the pot, the second place player (the player with the second highest score) may be awarded a second award which is preferably smaller than the first award, such as 30% of the pot, and the third place player (the player with the third highest score) may be awarded a third award which is preferably smaller than the second awards, such as 10% of the pot.

In one embodiment, the winnings are paid from a pot formed at least a partially from the wagers made by the players to enter the event. Of course, an operator of the event, such as a casino or “house” may take a commission or rake from those wagers. As one example, an event might have 10 players, each with a $100 buy-in, for a total amount wagered of $1000. The casino might take a 20% rake, leaving a pot of $800 to be paid to the winners. In the example above, the first place player would be awarded $480, the second place player $240 and the third place player $80.

Of course, in other embodiments, other numbers of players might be declared to be winners and the amounts which are awarded to those players might vary. For example, players could be paid winnings of a fixed amount or of different percentages or the like.

The winnings may be paid to the winning players in various manners, such as in the manners noted above. For example, monetary value credits might be awarded to a winning player, whereby a credit balance belonging to the player may be increased at the gaming machine that they are playing.

In one embodiment, as illustrated in FIG. 5, each player's activities may be graded, as at step S105. As one example, the player's outcome in the event may be graded for use in determining the player's rank or status, or a modification thereto. As one example, a C level player might win a sequence of three “C” level events. As a result, the player's ranking might be changed to B level. Of course, various methods may be used for determining a base grade or rank of a player and/or changing the player's grade or rank.

As noted, in a preferred embodiment, the event described above is presented to a plurality of players of gaming devices via one or more game servers and/or other servers. The game servers may generate and track game play information. One or more accounting servers may track credit balances, pots, rakes, winnings paid, etc. One or more player tracking servers may track player accounts having associated player IDs and generate and associate player rankings with those player accounts/IDs. Of course, all of these different servers may communicate with one another.

Of course, it is possible for such an event to be presented in peer-to-peer fashion as described above, wherein at least one gaming machine acts as the master and the gaming machines of other players act as slaves.

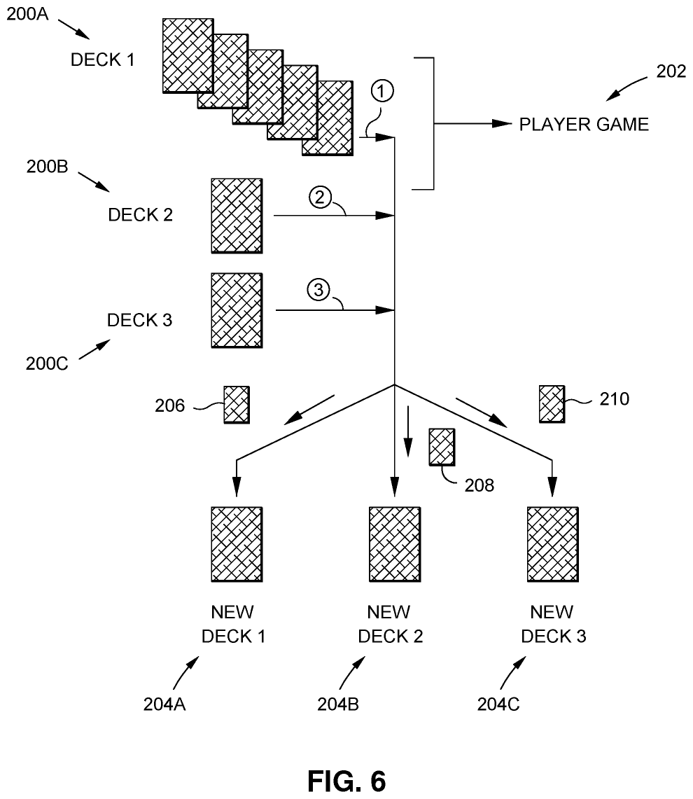

Game information for each game may be generated or determined in various ways. For example, the game server 108 may generate card data. This may be accomplished by utilizing the output of an RNG to randomly select cards from a set of playing cards (which set might comprise a virtual deck of one or more traditional decks of cards or other decks or sets of cards). In another embodiment, the game server might select cards from one or more decks of cards in the manner described below relative to FIG. 6.

The pools or events might have other features. For example, in one embodiment, a player might be permitted to fold and start a new hand in one or more rounds. As one example, each player may be given one or more fold/restart opportunities during each event.

The principles of the invention may be applied to groups or teams of players rather than just individual players. For example, teams of two or more players may play against one another. Preferably, the number of players on each team is the same. The players on each team may each be required to have the designated player ranking for the event or the entire team might be assigned a ranking and can then only play events that the assigned ranking permits.

Each player of each team may play games (such as poker hands) as described above. At the end of the event, the scores of all players on each team (or the highest scores, etc.) may be added together for a team total score. The highest scoring team(s) (preferably two or more teams) are declared the winners and may be awarded winnings such as in the manner described above. In one embodiment, winnings awarded to a team may be awarded in equal shares to each player of the team, or might be awarded based upon a hierarchy of scores of the players on the team from high to low, etc.).

One embodiment of the invention comprises methods of using different configurations of one or more decks of cards to present wagering card games. As disclosed herein, aspects of the invention comprise methods of head-to-head game play between one or more players, multi-player tournaments in which players play against one another, and group or team play. In one embodiment, in head-to-head and multi-player tournament play, each player is assigned their own set of cards comprising one or more decks of cards and each player is dealt cards from their own set of cards. In one embodiment, in group or team play, cards are dealt to all players from a single set of cards comprising one or more decks of cards.

One embodiment of the invention comprises a method for generating game information, and in particular, card information for a card game. In one embodiment, dealt cards are preferably determined by one of the player's gaming machines. In a preferred embodiment, an initiating player's gaming machine generates card data (or other game data) in the presentation of the game to the players, uses that data to present game information to the initiating player and transmits card data to the opponent's gaming machine for presentation of the game to the opponent. In this configuration, there is no game server but instead the gaming machines essentially operate in direct or peer-to-peer fashion to generate game information and present the game.

In addition, in one embodiment, the gaming machines may generate card information (or other game information) by other than the use of a random number generator (RNG). As one example, as illustrated in FIG. 6, each gaming machine may store information regarding a plurality of shuffled decks of cards (e.g. 200A, 200B, 200C, etc.). In the play of a game, cards may be selected from one or more of those decks of cards, as at 202. For example, the initiating player's gaming machine may select cards from the first deck of cards 200A. That card information may be used by the player's gaming machine to display their initial dealt hand. Additional cards selected by the initiating player's gaming machine may be transmitted to the opponents gaming machine, causing it to display a hand to the opposing player.

At the end of the game, the initiating player's gaming machine may take cards from the multiple decks of cards and reform them into a plurality of corresponding new decks of cards 204A, 204B, 204C). This may comprise, for example, the gaming machine taking one card at a time from each of the old decks and assigning them to one of the new decks. For example, as illustrated in FIG. 6, a first card 206 might be taken from the old first deck 200A and might be assigned to a first new deck 204A, a second card 208 might be taken from the old second deck 200B and might be assigned to a second new deck 204B, and a third card 210 might be taken from the old third deck 200C and might be assigned to the third new deck 204C. Then, first, second and third cards might be taken from the second old deck 200B and might be assigned to the new decks in a similar fashion. Then, cards might be taken from the third old deck 200C and might be assigned to the new decks in a similar fashion. In this manner, the cards from the original decks are randomized into new decks. Of course, assignment of cards may be overridden to prevent the same card from being assigned more than one time to a single deck of cards and to ensure that each card in a standard deck is represented in each of the newly formed decks of cards (although the cards in the stack will be randomized in their order). It will also be appreciated that the decks or stacks of cards might comprise multiple deck stacks. For example, the gaming machine might track 3 stacks of cards, each stack including 3 decks or cards, wherein when a game is presented, cards are selected or dealt from one of those stacks. In such a configuration, the assignment of cards is preferably controlled to ensure that each stack of 3 decks or cards contains a combination of cards comprising three standard decks of cards (e.g. that no cards are missing or that some cards are not overly represented, such as to ensure that three A [symbol] appear in the stack and not merely two or four).

In one embodiment, new decks may be formed after each game is played. In another embodiment, new decks may be formed after all of the existing decks have been used to present a game. In one embodiment, to emphasize that the game is being played with stored and shuffled decks or stacks of cards rather than by an RNG number selection, a graphic representation of the decks or stacks of cards and the shuffling or card assignment after each game into new decks/stacks may be provided to the player.

In one embodiment, the manner of card-reassignment from old decks to new decks may vary, such as in the order, number of cards, etc. moved from old decks to new decks. Also, the cards may be identified in various manners, such as by graphic images, bar codes, alpha and/or numeric identifiers, etc., by which the gaming machine may track each card and its associated with a particular deck or stack of cards.

In one embodiment, the gaming machine stores information regarding the decks, including the order of their cards and their values. Thus, when the gaming machine “deals” cards, it selects cards from the memory of stored cards in sequence starting with the first card in the deck.

While in the example illustrated in FIG. 6 there are three stacks or decks of cards, the invention may be applied to two or more stacks or decks of cards or greater than three stacks or decks of cards, such as four or more. Also, as noted herein, this aspect of the invention may be applied to a variety of card games and to games, gaming machines and gaming tables.

In one embodiment, each non-initiating gaming machine sends opposing player inputs to the initiating gaming machine. For example, after the initiating gaming machine transmits information regarding five (5) dealt cards for an opposing player's hand to the opposing player's gaming machine, the opposing player might provide input to their machine to discard two (2) cards. This input may be routed from the opposing player's gaming machine to the initiating player's gaming machine, thus resulting in the initiating player's gaming machine dealing two new cards. Information regarding those two new cards is transmitted from the initiating player's gaming machine to the opposing player's gaming machine.

In one such configuration, a virtual deck of cards may be assigned to each player and the cards which are dealt to the player during a game may be dealt or selected from the deck which has been assigned to them. The decks of cards may then be shuffled in the manner described above and the shuffled decks may then be re-assigned to each player for the next game. In this configuration, the hands which are dealt to each player are dealt from different decks, thus offering each player the same opportunity for all game outcomes (e.g. more than one player could receive the same Four of a Kind hand, etc.).

Embodiments of the invention have various advantages. One advantage of the invention is a method for linking players for multi-player play, where opposing players might comprise friends, players of an associated group, non-friend players who have a particular rating or ranking, or players of designated available events. In some embodiments, the player may “invite” opposing players, including by having the system transmit an invite request to a communication device of the other players(s). An advantage to this aspect of the invention is that a player either plays someone they know (e.g. a friend or member of a linked group) or only plays against other players (such as other players who are not friends or members of a linked group, including players who enroll in an event) if the players have a similar player rating or ranking (or at least one that is not below the player, and preferably not above). For example, in an embodiment where a player joins a multi-player event, the player is ensured that they will play players of a designated rating or skill level. In one embodiment, a player can elect to play against a player of a higher rating or skill level, such as to challenge themselves.

Another advantage is a multi-player event, such as a multi-player poker event, where multiple players may be declared winners and receive winnings, as opposed to traditional multi-player table poker games where only a single player wins each game and they are awarded the entire pot of winnings to the exclusion of all other players.

Another advantage of the invention is an exciting event, such as a poker game, where the player plays against other players without having to play against them in person at a gaming table. The invention also allows players to form teams and, when ranking is utilized, allows players to play against other players who have similar rankings or levels in order to give the player a fairer opportunity to win.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming device which is configured to generate card information for use in presenting a card game comprising:
a housing;
a monetary value accepting device for accepting monetary value for use as a wager to play said card game;
a video display;
a processor;
a memory; and
machine-readable code stored in said memory and configured to cause said processor to:
(a) store information regarding a first plurality of cards comprising a first deck of cards and a second plurality of cards comprising a second deck of cards;
(b) select a first number of cards from said first deck of cards;
(c) cause said video display to display images representing said first number of cards as part of the presentation of said card game;
(d) determine an outcome of said card game;
(e) shuffle said first plurality of cards and said second plurality of cards into a third deck of cards and a fourth deck of cards, comprising iteratively assigning one or more cards from each of said first and second decks of cards to said third deck of cards and one or more cards from each of said first and second decks of cards to said fourth deck of cards until no more cards remain in said first and second decks; and
(f) store information regarding said cards comprising said third and fourth decks of cards for use in presenting another card game.

2. The gaming device in accordance with claim 1, wherein said stored information regarding said first deck of cards and said second deck of cards comprises information representing said cards and a sequence of said cards in said first and second decks.

3. The gaming device in accordance with claim 1, further comprising transmitting information regarding a second number of cards selected from said first device of cards to a second gaming device.

4. The gaming device in accordance with claim 1, wherein said first and second decks of cards each comprise 52 cards.

5. The gaming device in accordance with claim 1, wherein said first and second decks of cards each comprise multiple decks of 52 cards.

6. The gaming device in accordance with claim 1, wherein said shuffling comprises iteratively assigning one card from said first deck to each of said third deck and said fourth deck and then assigning one card from said second deck to said third deck and said fourth deck.

7. The gaming device in accordance with claim 1, further comprising causing said video display to graphically display information regarding said first and second decks and movement of said assigned cards to said third and fourth decks.

8. The gaming device in accordance with claim 1, wherein said machine-readable code is configured to cause said processor to prevent assignment of duplicates of the same card from said first and second decks to either said third and fourth deck.
